(19) United States
(12) Patent Application Publication
(10) Pub. No.: US 2007/0085856 A1
(43) Pub. Date: Apr. 19, 2007

(54) Method for Adjusting Hue or Saturation of an Individual Color in a Divided Color Space

(76) Inventors: Tsung-Ming Wang, Hsinchu (TW); Hsi-Chun Huang, Hsinchu (TW); Chao-Chee Ku, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/307,474

(22) Filed: Feb. 9, 2006

(30) Foreign Application Priority Data
Oct. 13, 2005 (TW) 094135712

(51) Int. Cl. G09G 5/02

(52) U.S. Cl. 345/591

(57) ABSTRACT

Color adjustment includes dividing a color space into m tints, and then dividing each tint into n small areas. A chromaticity of a first color is adjusted by a first predetermined amount. An amount smaller than the first predetermined amount is generated according to the first predetermined amount. A chromaticity of a color close to the first color is adjusted by the amount smaller than the first predetermined amount. The adjusted amount of each small area decreases progressively. Similarly, a gain of a second color is adjusted by a second predetermined amount. An amount smaller than the second predetermined amount is generated according to the second predetermined amount. A gain of a color close to the second color is adjusted by the amount smaller than the second predetermined amount. Similarly, the adjusted amount of each small area decreases progressively.

### BACKGROUND OF THE INVENTION

1. Field of the Invention

The present invention relates to an image processing method, and more particularly, to a method for adjusting hue or saturation of an individual color in a divided color space without causing contour artifacts.

2. Description of the Prior Art

With the improvement of image processing technology, the functionality of display devices increases. Several types of TVs are capable of adjusting picture color, such as red, green grass color, or bright blue sky color, without influencing other colors.

Adjustment of the tint is capable of changing the color of an image. In the prior art, the chroma (U, V) or (Cb, Cr) are adjusted to change the color in signal YUV or YCbCr. However, after changing the chromaticity, the colors nearby are influenced correspondingly. This causes discontinuity of color, namely, the so-called contour artifacts.

Please refer to FIG. 1. FIG. 1 is a diagram of a prior art color space 10 in a chromatic plane (U, V). The horizontal axis is a U axis, and the vertical axis is a V axis. The color space 10 includes one red axis R, one green axis G, one blue axis B, one yellow axis Y, one cyan axis C, and one magenta axis M. Above-mentioned six color axes divide the color space 10 to six regions A1-A6.

Please refer to FIG. 2. FIG. 2 is a diagram illustrating the adjustment of the chromaticity in the color space 10 of FIG. 1. If a user wants to adjust the red axis R clockwise 10 degrees, two regions A1 and A6 near the red axis R are rotated clockwise 10 degrees. Because of the 10-degree clockwise rotation, the regions A6 and A5 have some overlap. This makes the color near the magenta axis M change. This causes discontinuity of the color space, namely, the so-called contour artifacts. Also because of the 10-degrees clockwise rotation, the regions A1 and A2 have a blank gap. This makes the color near the yellow axis Y change, causing a discontinuity of the color space.

Please refer to FIG. 3. FIG. 3 is a diagram of transforming the angles of the regions in FIG. 2 into a function. The vertical axis Δθ represents the angle of each region, and the horizontal axis represents each region. Such as in the example of FIG. 2, the position of the central point (marked with a dotted line) represents the red axis R that is to be adjusted. The region on the left of the dotted line represents 10 degrees of A1 clockwise rotation, and the region on the right of the dotted line represents 10 degrees of A6 clockwise rotation (clockwise is positive). The whole figure represents a horizontal straight line Δθ=10° in the regions A1 and A6, no matter in which region (A1 or A6).

With the adjustment of the saturation, an image can be made to look much more brightly colored. In the prior art, the gains of the chroma (U, V) or (Cb, Cr) are adjusted to raise the vividness in the signal YUV or YCbCr. One method of doing this is to multiply the chroma by a saturation index α. However, after changing the gain, nearby color is influenced correspondingly. This causes a discontinuity of color or contour artifacts.

Please refer to FIG. 4. FIG. 4 is a diagram illustrating the adjustment of the gain in the color space 10 of FIG. 1. Suppose that the user wants to adjust the gain of the red axis R from 32 to 52 (the gain of each color axis is 32 and the gain coefficient is 32/32=1, the gain after adjustment is 52 and the gain coefficient is 52/32=1.63). Thereby the gains of the regions A1 and A6 near the red axis R are adjusted to 52, while other regions are maintained at 32. Because the gain of A6 is adjusted to 52 and the gain of A5 is still 32, the two sides of the magenta axis M have different gains. This causes a gap and its value is 20. By the same reason, because the gain of A1 is adjusted to 52 and the gain of A2 is still 32, the two sides of the yellow axis Y have different gains. This causes discontinuity of the color space or contour artifacts.

Please refer to FIG. 5. FIG. 5 is a diagram showing transforming the gains of the regions in FIG. 4 into a function. The vertical axis Δα represents the gain coefficient of each region, and the horizontal axis represents each region. Such as in the example of FIG. 4, the position of the central point (marked with a dotted line) represents the red axis R that is to be adjusted. The region on the left of the dotted line represents adjusting the gain of A1 to 52 (gain coefficient=1.63), and the region on the right of the dotted line represents adjusting the gain of A6 to 52 (gain coefficient=1.63). The whole figure represents a horizontal straight line Δα=1.63 in the regions A1 and A6, no matter in which region (A1 or A6) the gain coefficient is 1.63.

As mentioned above, the prior art method is capable of adjusting the chromaticity to change the color, and adjusting the saturation to make the image look much more brightly colored. However, changing the chromaticity or the saturation causes discontinuity of color, namely, so-called contour artifacts. This lowers the quality of the image.

### SUMMARY OF THE INVENTION

According to the claimed invention, a method for adjusting a tint of a color without causing contour artifacts comprises adjusting a chromaticity of a first color by a first predetermined amount; generating an amount smaller than the first predetermined amount according to the first predetermined amount; and adjusting a chromaticity of a color close to the first color by the amount smaller than the first predetermined amount.

According to another embodiment, a method for adjusting a tint of a color without causing contour artifacts comprises adjusting a saturation of a second color by a second predetermined amount; generating an amount smaller than the second predetermined amount according to the second predetermined amount; and adjusting a saturation of a color close to the second color according to the amount smaller than the second predetermined amount.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art color space in a chromatic plane (U, V).

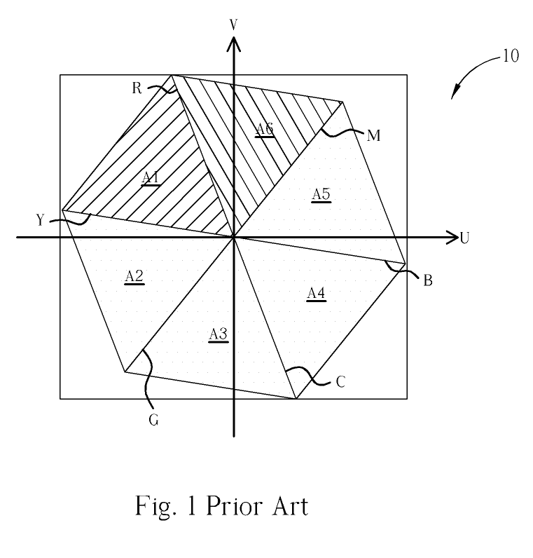

FIG. 2 is a diagram illustrating a method of adjusting a chromaticity of a color space according to the prior art.

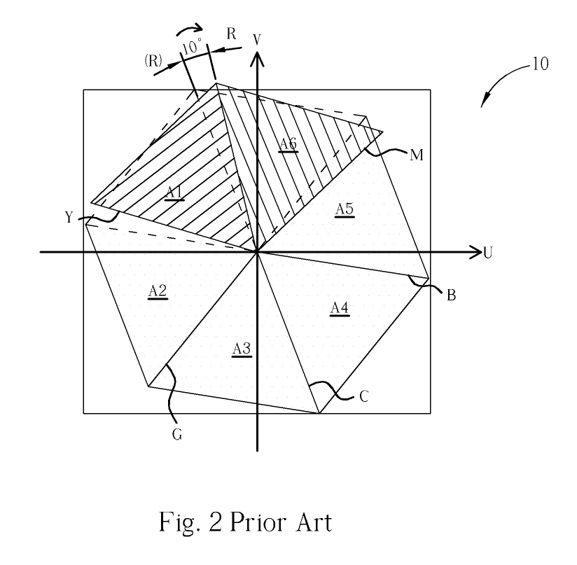

FIG. 3 is a diagram showing transforming the rotation angle of each region in FIG. 2 into a function.

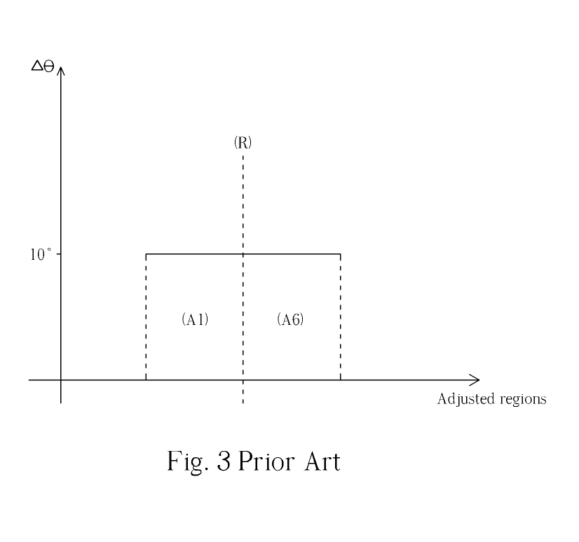

FIG. 4 is a diagram illustrating a method of adjusting a gain of a color space according to the prior art.

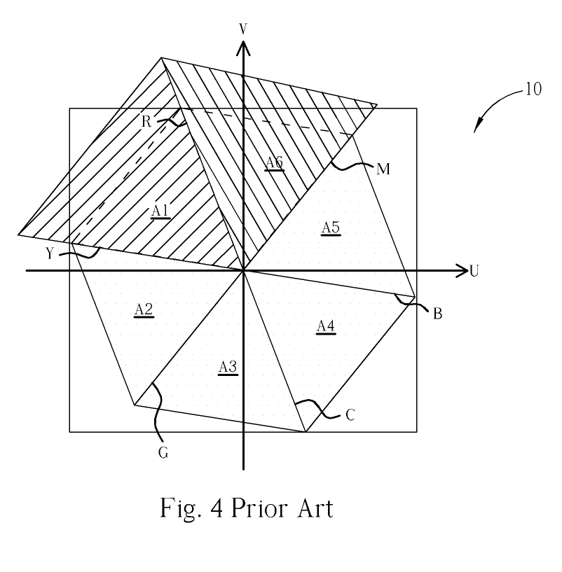

FIG. 5 is a diagram showing transforming the gain of each region in FIG. 4 into a function.

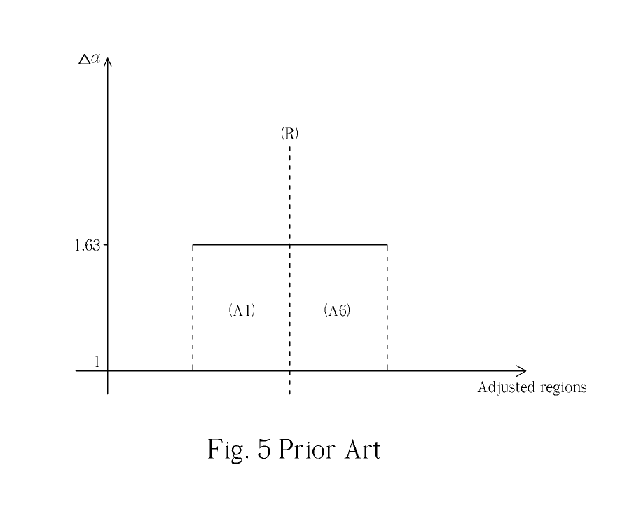

FIG. 6 is a diagram illustrating a method of adjusting a rotation angle of a color space according to an embodiment of the present invention.

FIG. 7 is a diagram showing transforming the rotation angle of each small area in FIG. 6 into a function.

FIG. 8 is a diagram showing transforming the adjusting rotation angle of each small area in FIG. 6 into another function.

FIG. 9 is a diagram illustrating a method of adjusting a gain of a color space according to another embodiment of the present invention.

FIG. 10 is a diagram showing transforming a gain of each small area in FIG. 9 into a function.

FIG. 11 is a diagram showing transforming a gain of each small area in FIG. 9 into another function.

### DETAILED DESCRIPTION

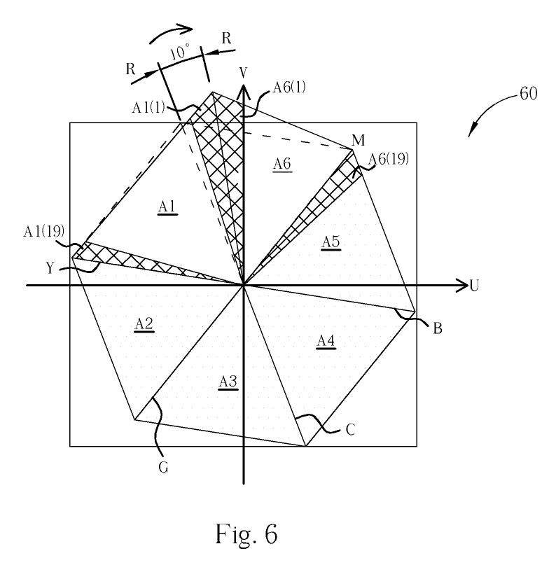

Please refer to FIG. 6. FIG. 6 is a diagram illustrating adjustment of chromaticity in a color space 60 according to an embodiment of the present invention. Six axes are used to divide the color space 60 into six regions A1-A6 (m=6). The axes are a red axis R, a green axis G, a blue axis B, a yellow axis Y, a cyan axis C, and a magenta axis M. Each region A1(n)-A6(n) is divided into 20 small areas, wherein n equals to 0-19. If a user wants to adjust the red axis R clockwise 10 degrees, only two regions A1 and A6 near the red axis R are affected. Considering the region A1 (between the red axis R and the yellow axis Y), the rotation angles depend on the position of the small areas and decrease progressively from the red axis R to the yellow axis Y. The nearest small area A1(1) of the red axis R is rotated 9.5 degrees, the small area A1(2) is rotated 9 degrees, and so on, until the small area A1(19), which is rotated 0.5 degrees. The yellow axis Y is not rotated. Considering the region A6 (between the red axis R and the magenta axis M), the rotation angles depend on the position of the small areas and decrease progressively from the red axis R to the magenta axis M. The nearest small area A6(1) of the red axis R is rotated 9.5 degrees, the small area A6(2) is rotated 9 degrees, and so on, until the small area A6(19), which is rotated 0.5 degrees. The magenta axis M is not rotated. Therefore, the difference in rotation angles is limited to 0.5 degrees and contour artifacts resulting from rotation angles are improved.

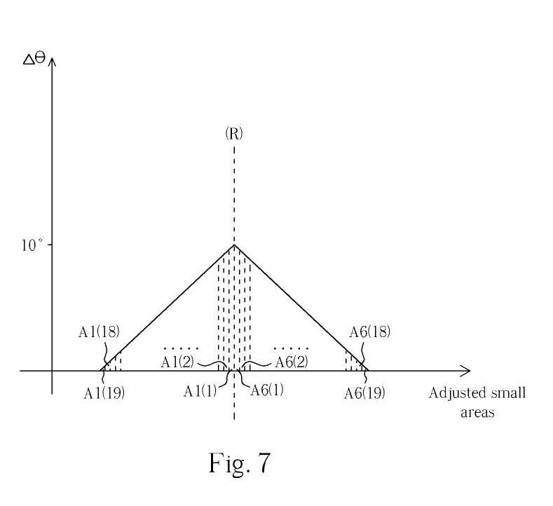

Please refer to FIG. 7. FIG. 7 is a diagram showing transforming the angles of the small areas in FIG. 6 into a function. The vertical axis Δθ represents the angle of each small area, and the horizontal axis represents each small area. Such as in the example of the FIG. 6, the position of the central point (marked with a dotted line) represents the red axis R that is to be adjusted. The region on the left of the dotted line represents the rotation angles of the small areas A1(19)-A1(0) in order, the angles increasing progressively towards the red axis R. The region on the right of the dotted line represents the rotation angles of the small areas A6(0)-A6(19) in order, the angles decreasing progressively from the red axis R. The whole figure presents a linear function having a high central point and decreasing progressively towards two sides.

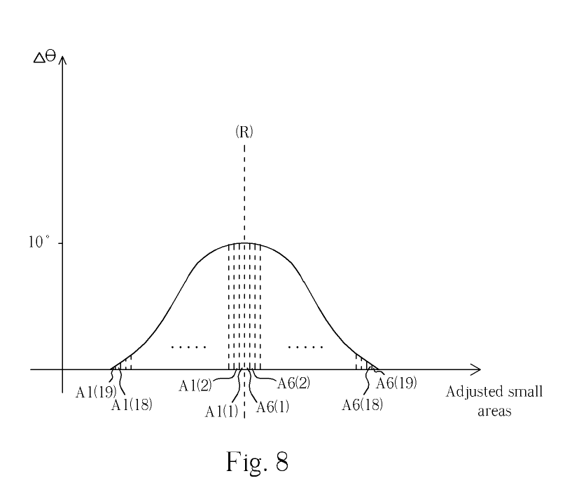

The function that transforms the angles of each small area is not necessarily a linear function. Please refer to FIG. 8. FIG. 8 is a diagram of transforming the angles of the small areas into a function according to another embodiment of the present invention. The vertical axis Δθ represents the angle of each small area, and the horizontal axis represents each small area. The difference between this embodiment and the embodiment and FIG. 6 is that the whole figure represents a Gaussian function having a high central point and decreasing progressively to two sides.

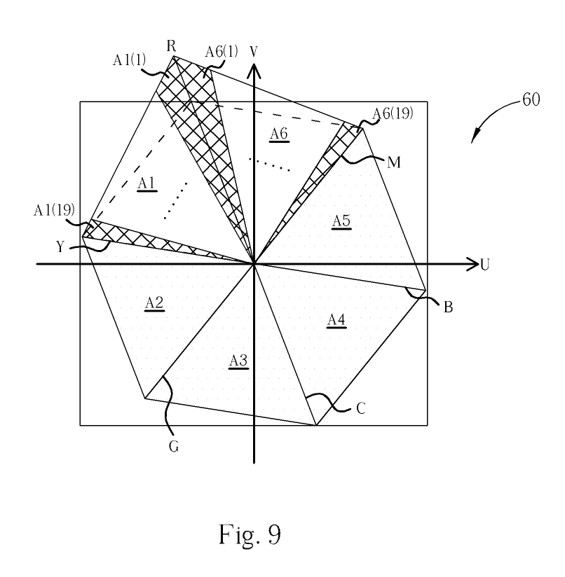

Please refer to FIG. 9. FIG. 9 is a diagram illustrating adjustment of the gain in the color space 60 according to another embodiment of the present invention. Six axes are used to divide the color space 60 into six regions A1-A6 (m=6). The axes are the red axis R, the green axis G, the blue axis B, the yellow axis Y, the cyan axis C, and the magenta axis M. Each region A1(n)-A6(n) is divided into 20 small areas, wherein n equals to 0-19. If the user wants to adjust the gain of the red axis R from 32 to 52 (the gain of each color axis is 32 and the gain coefficient is 32/32=1, the gain after adjusting is 52 and the gain coefficient is 52/32=1.63), only two regions A1 and A6 near the red axis R are affected. Considering the region A1 (between the red axis R and the yellow axis Y), the gain values depend on the positions of the small areas and decrease progressively from the red axis R to the yellow axis Y. The gain of the nearest small area A1(1) of the red axis R is 51, the gain of the small area A1(2) is 50, and so on, until the small area A1(19), which has a gain of 33. The gain of the yellow axis Y is 32. Consider the region A6 (between the red axis R and the magenta axis M), the gain values depend on the positions of the small areas and decrease progressively from the red axis R to the magenta axis M. The gain of the nearest small area A6(1) of the red axis R is 51, the gain of the small area A6(2) is 50, and so on, until the small area A6(19), which has a gain of 33. The gain of the magenta axis M is 32. Therefore the gain difference is limited in 1 (1/32=3%) and contour artifacts resulting from the gain difference are improved.

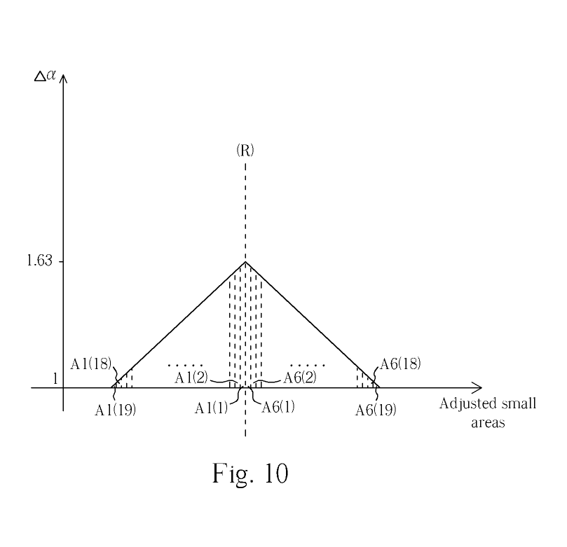

Please refer to FIG. 10. FIG. 10 is a diagram of transforming the gains of the small areas in FIG. 9 into a function. The vertical axis Δα represents the gain coefficient of each small area, and the horizontal axis represents each small area. Such as in the example of the FIG. 9, the position of the central point (marked with a dotted line) represents the red axis R that is to be adjusted. The region on the left of the dotted line represents the gain coefficients of the small areas A1(19)-A1(0) in order, the gain coefficients increasing progressively towards the red axis R. The region on the right of the dotted line represents the gain coefficients of the small areas A6(0)-A6(19) in order, the gain coefficients decreasing progressively towards the red axis R. The whole figure represents a linear function with a high central point and decreasing progressively to two sides.

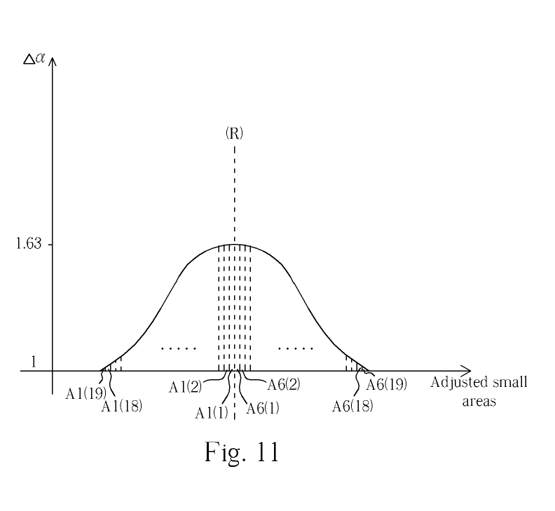

The function that transforms the gains of each small area is not necessarily a linear function. Please refer to FIG. 11. FIG. 11 is a diagram of transforming the gains of the small areas into a function according to another embodiment of the present invention. The vertical axis Δα represents the gain coefficient of each small area, and the horizontal axis represents each small area. The difference between this embodiment and FIG. 9 is that the whole figure represents a Gaussian function having a high central point and decreasing progressively to two sides.

The present invention is based on the chromatic plane (U, V) or (Cb, Cr). The chromatic signal YUV or YCbCr and the color model RGB have a linear conversion formula, which can be expressed as a 3×3 matrix. Hence, the chromatic signal YUV or YCbCr can be transformed to get a new color model, such as RGB.

The above-mentioned embodiments illustrate but do not limit the present invention. The values of m and n can be changed according to user preference. If the color space is divided into smaller areas (larger m and n), the contour artifacts of adjacent colors are lowered. However, dealing with the image consumes more time. The function that transforms the angles of each small area is not necessarily a linear function or a Gaussian function. A non-linear function having a high central point and decreasing progressively towards two sides is also acceptable. Similarly, the function that transforms the gains of each small area is not necessarily a linear function or a Gaussian function. A non-linear function having a highest central point and decreasing progressively towards two sides is also acceptable.

In conclusion, the present invention provides a method for adjusting the hue or saturation of an individual color in a divided color space. The color space is divided into m tints, and then each tint is divided into n small areas. An angle of a first color is adjusted by a first determined value, and an angle of a color close to the first color is adjusted according to a value smaller than the first determined value. The rotation angle of each small area decreases progressively. Similarly, a gain of a second color is adjusted by a second determined value, and a gain of a color close to the second color is adjusted according to a value smaller than the second determined value. Likewise, the gain of each small area decreases progressively. Therefore, the difference between adjacent small areas is limited and contour artifacts are improved.

In comparison to the prior art, the present invention divides the color space into several small areas and adjusts different angles or gains according to position. Therefore, the difference between adjacent small areas is limited. The present invention achieves the objectives of changing the color and making the image look much more brightly colored, improving contour artifacts, and increasing the quality of the image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting a tint of a color without causing contour artifacts, the method comprising:
adjusting a chromaticity of a first color by a first predetermined amount;
generating an amount smaller than the first predetermined amount according to the first predetermined amount; and
adjusting a chromaticity of a color close to the first color by the amount smaller than the first predetermined amount.

2. The method of claim 1 further comprising:
adjusting a saturation of a second color by a second predetermined amount; and
adjusting a saturation of a color close to the second color.

3. The method of claim 2 wherein adjusting the saturation of the color close to the second color is adjusting the saturation of the color close to the second color by an amount smaller than the second predetermined amount.

4. The method of claim 3 further comprising generating the amount smaller than the second predetermined amount according to the second predetermined amount.

5. The method of claim 4 wherein generating the amount smaller than the second predetermined amount according to the second predetermined amount comprises generating a Gaussian function which decreases progressively from the second predetermined amount; and wherein adjusting the saturation of the color close to the second color by the amount smaller than the second predetermined amount comprises adjusting the saturation of the color close to the second color according to the Gaussian function.

6. The method of claim 4 wherein generating the amount smaller than the second predetermined amount according to the second predetermined amount comprises generating a linear function which decreases progressively from the second predetermined amount; and wherein adjusting the saturation of the color close to the second color by the amount smaller than the second predetermined amount comprises adjusting the saturation of the color close to the second color according to the linear function.

7. The method of claim 1 wherein generating the amount smaller than the first predetermined amount according to the first predetermined amount comprises generating a Gaussian function which decreases progressively from the first predetermined amount; and wherein adjusting the chromaticity of the color close to the first color by the amount smaller than the first predetermined amount comprises adjusting the chromaticity of the color close to the first color according to the Gaussian function.

8. The method of claim 1 wherein generating the amount smaller than the first predetermined amount according to the first predetermined amount comprises generating a linear function which decreases progressively from the first predetermined amount; and wherein adjusting the chromaticity of the color close to the first color by the amount smaller than the first predetermined amount comprises adjusting the chromaticity of the color close to the first color according to the linear function.

9. The method of claim 1 further comprising:
adjusting a saturation of the first color by a second predetermined amount; and
adjusting a saturation of a color close to the first color.

10. The method of claim 9 wherein adjusting the saturation of the color close to the first color is adjusting the saturation of the color close to the first color by an amount smaller than the second predetermined amount.

11. The method of claim 10 further comprising generating the amount smaller than the second predetermined amount according to the second predetermined amount.

12. The method of claim 11 wherein generating the amount smaller than the second predetermined amount according to the second predetermined amount comprises generating a Gaussian function which decreases progressively from the second predetermined amount; and wherein adjusting the saturation of the color close to the first color according to the amount smaller than the second predetermined amount comprises adjusting the saturation of the color close to the first color according to the Gaussian function.

13. The method of claim 11 wherein generating the amount smaller than the second predetermined amount according to the second predetermined amount comprises generating a linear function which decreases progressively from the second predetermined amount; and wherein adjusting the saturation of the color close to the first color according to the amount smaller than the second predetermined amount comprises adjusting the saturation of the color close to the first color according to the linear function.

14. A method for adjusting a tint of a color without causing contour artifacts, the method comprising:
adjusting a saturation of a first color by a first predetermined amount;
generating an amount smaller than the first predetermined amount according to the first predetermined amount; and
adjusting a saturation of a color close to the first color by the amount smaller than the first predetermined amount.

15. The method of claim 14 further comprising:
adjusting a chromaticity of a second color by a second predetermined amount; and
adjusting a chromaticity of a color close to the second color.

16. The method of claim 15 wherein adjusting the chromaticity of the color close to the second color is adjusting the chromaticity of the color close to the second color by an amount smaller than the second predetermined amount.

17. The method of claim 14 further comprising:
adjusting a chromaticity of the first color by a second predetermined amount; and
adjusting a chromaticity of a color close to the first color.

18. The method of claim 17 wherein adjusting the chromaticity of the color close to the first color is adjusting the chromaticity of the color close to the first color by an amount smaller than the second predetermined amount.

19. The method of claim 14 wherein generating the amount smaller than the first predetermined amount according to the first predetermined amount comprises generating a Gaussian function which decreases progressively from the first predetermined amount; and wherein adjusting the saturation of the color close to the first color by the amount smaller than the first predetermined amount comprises adjusting the saturation of the color close to the first color according to the Gaussian function.

20. The method of claim 14 wherein generating the amount smaller than the first predetermined amount according to the first predetermined amount comprises generating a linear function which decreases progressively from the first predetermined amount; and wherein adjusting the saturation of the color close to the first color by the amount smaller than the first predetermined amount comprises adjusting the saturation of the color close to the first color according to the linear function.
